(19) United States
(12) Patent Application Publication
(10) Pub. No.: US 2007/0122630 A1
(43) Pub. Date: May 31, 2007

(54) CO-EXTRUSION OR TANDEM EXTRUSION OF SURFACE PROTECTION FILMS

(75) Inventor: Douglas Worthen, Lowell, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: WORTHEN INDUSTRIES, Nashua, NH (US)

(21) Appl. No.: 11/557,803

(22) Filed: Nov. 8, 2006

Related U.S. Application Data
(60) Provisional application No. 60/734,502, filed on Nov. 8, 2005.

(51) Int. Cl. B32B 27/40

(52) U.S. Cl. 428/423.1; 156/244.11

(57) ABSTRACT

A surface protection film for protecting an exposed surfaces from harsh environments weathering may comprise co-extruding a first resin of a polyurethane and a second resin (for example, polyester or polypropylene) through an AB feed block onto a carrier (for example, polyester, polypropylene, or polyethylene). The carrier will protect the polyurethane on a first side while the second resin will protect the polyurethane on a second side opposite the first side. Alternatively, the first and second resins may be co-extruded through an ABA block such that the polyurethane is substantially sandwiched between two layers of the second resin with the need for a carrier film. According to another embodiment, the first and second resins may be tandemly extruded. The first resin may be extruded onto a carrier film while the second resin may be tandemly extruded onto a surface of the first layer opposite the carrier film.

### CROSS REFERENCE TO RELATED APPLICATIONS

This application claims the benefit of U.S. Provisional Patent Application No. 60/734,502, filed Nov. 8, 2006 which is hereby fully incorporated by reference.

### TECHNICAL FIELD

The present disclosure relates to protective films and more particularly, relates to method and apparatus for manufacturing polyurethane surface protective films.

### BACKGROUND INFORMATION

Surface protection films may be made from polyurethane and may be used to protect land or marine craft exteriors from harsh environments and weathering. Polyurethane may be used in surface protection environments because, in part, of its high abrasion resistance, UV resistance, elongation, resistance to chemicals and fungus, and ease of fabrication. Surface protection polyurethane films are commonly known for their automotive applications, yet have recently found many useful applications in several other markets.

There currently exists several known methods for manufacturing polyurethane film on a flat die line for surface protection applications. One such method features an extruder 2, FIG. 1, (for example, fed from a hopper 3 or the like) that extrudes polyurethane 4 at a thickness between 4-12 mils onto a 0.5-3 mils polyester, polypropylene, or polyethylene carrier 5 which may be unwound from a roll 6. The combination of the polyurethane 4 and carrier 5 may then wound onto a roll 9. The exposed surface 7 (i.e., the non-carrier side) of the polyurethane 4 may be in contact with the backside 8 of the carrier 5 when wound onto the roll 9.

This method suffers from several disadvantages. For example, the non-carrier surface 7 of the polyurethane 4 may develop imperfections and inconsistencies when wound onto the roll 9 because of uneven contact and pressure with backside of carrier 5. Because the carrier 5 may be unrolled from a roll 6, the carrier 5 may often have imperfections due to the winding of the roll 6. The imperfections of the carrier 5 may then be transferred onto polyurethane 4.

Another known method for manufacturing polyurethane film on a flat die line features an extruder 2, FIG. 2, (for example, fed from a hopper 3 or the like) which extrudes polyurethane 4 at a thickness between 4-12 mils onto a 0.5-3 mils polyester, polypropylene, or polyethylene carrier 5 (often unwound from a roll 6). A separate film 11 (for example, a film similar to the carrier 5) may be unwound from a roll 12 and introduced at the nip point 13 (the point 13 where the molten polyurethane 4 comes out of the die 14 and passes between two rolls 15). The second film 11 may be used to protect the non-carrier side 7 of the polyurethane 4 when wound onto roll 9.

Unfortunately, introducing the separate film 11 may result in wrinkles and air pockets occasionally forming at the nip point 13. These wrinkles and air pockets may cause imperfections in surface of polyurethane 4. Additionally, any imperfections in introduced film 11 or the carrier 5 (e.g., due to the winding of the rolls 6, 12) may affect the polyurethane 4 surfaces.

Yet another known method for manufacturing polyurethane film on a flat die line features an extruder 2, FIG. 3, (for example, fed from a hopper 3 or the like) that extrudes polyurethane 4 at a thickness of between 4-12 mils between two very smooth chilled rolls 16. An interleaf 17 (usually 0.5-2 mils polyethylene) may be unwound from a roll 18 and introduced before the polyurethane 4 is wound onto roll 9 but after the polyurethane 4 has crystallized in order to keep the material from blocking.

Unfortunately, winding two separate, unbonded films together (for example, in this case the interleaf 17 and the polyurethane film 4) may be difficult to do evenly due, in part, to the variations between the gauge, elongation, etc. properties of the two films 4, 17. The winding process may result in wrinkles, air pockets, pressure marks, and other imperfections being created in the polyurethane 4 surfaces.

Accordingly, what is needed is an improved apparatus and method for manufacturing polyurethane film on a flat die line. The improved apparatus and method should preferably minimize the number of imperfections in the polyurethane film. Additionally, the improved apparatus and method should be economically viable.

It is important to note that the present disclosure is not intended to be limited to a system or method which must satisfy one or more of any stated objects or features of the invention. It is also important to note that the present disclosure is not limited to the preferred, exemplary, or primary embodiment(s) described herein. Modifications and substitutions by one of ordinary skill in the art are considered to be within the scope of the present disclosure, which is not to be limited except by the following claims.

### SUMMARY

According to one embodiment, the present disclosure features a surface protection film and a method of manufacturing the same. A first resin comprising a polyurethane and a second resin (for example, but not limited to, a polyester or a polypropylene) may be co-extruded through an AB feed block to form a co-extruded film having a first layer of the first resin and a second layer of the second resin. An exterior surface of the first resin of the co-extruded film may be placed onto a carrier film. The carrier film protects the exterior surface of the first layer and the second layer protects a second side of the first layer generally opposite the exterior surface. The carrier film and the second layer may optionally be substantially coextensive with the first layer.

According to another embodiment, the present disclosure features a surface protection film and a method of manufacturing the same comprising co-extruding a first resin of a polyurethane and a second resin (for example, but not limited to, a polyester or a polypropylene) through an ABA feed block. The co-extruded film may comprise a first layer of the first resin and a second and a third layer of the second resin substantially contacting a first and a second generally opposite exterior surface of the first layer. The second and third layers protect the first and the second exterior surfaces of the first layer such that the co-extruded film does not require a carrier film.

According to yet another embodiment, the present disclosure features a surface protection film and a method of manufacturing the same comprising extruding a first layer of a first resin of polyurethane and placing a first surface of the first layer onto a carrier film. A second layer of a second resin may be tandemly extruded with the first layer onto a second surface of the first layer generally opposite the first surface. The second layer protects the first surface of the first layer and the carrier film protects the second side of the first layer.

### BRIEF DESCRIPTION OF THE DRAWINGS

These and other features and advantages of the present disclosure will be better understood by reading the following detailed description, taken together with the drawings wherein:

FIG. 1 is a block diagram showing one embodiment of the prior art methods of manufacturing polyurethane film on a flat die line;

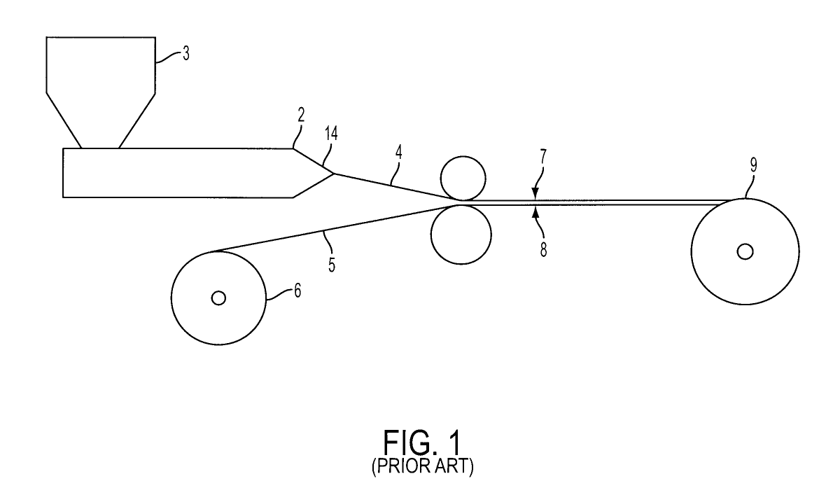

FIG. 2 is a block diagram showing another embodiment of the prior art methods of manufacturing polyurethane film on a flat die line;

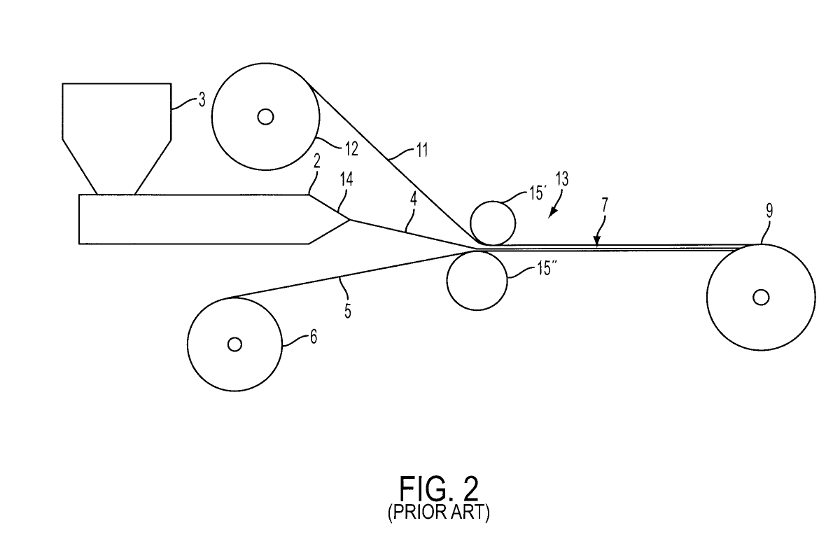

FIG. 3 is a block diagram showing yet another embodiment of the prior art methods of manufacturing polyurethane film on a flat die line;

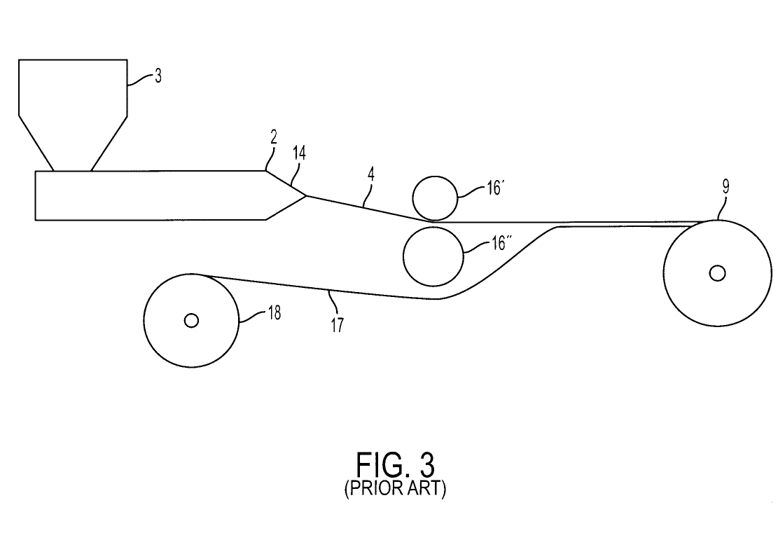

FIG. 4 is a block diagram showing one embodiment of an apparatus for manufacturing polyurethane film on a flat die line according to one embodiment of the present disclosure;

FIG. 5 is a flow chart of one embodiment of the method of manufacturing polyurethane film using the apparatus shown in FIG. 4;

FIG. 6 is a block diagram showing another embodiment of an apparatus for manufacturing polyurethane film on a flat die line according to one embodiment of the present disclosure;

FIG. 7 is a flow chart of one embodiment of the method of manufacturing polyurethane film using the apparatus shown in FIG. 6;

FIG. 8 is a block diagram showing yet another embodiment of an apparatus for manufacturing polyurethane film on a flat die line according to one embodiment of the present disclosure; and

FIG. 9 is a flow chart of one embodiment of the method of manufacturing polyurethane film using the apparatus shown in FIG. 8.

### DETAILED DESCRIPTION OF THE PREFERRED EMBODIMENTS

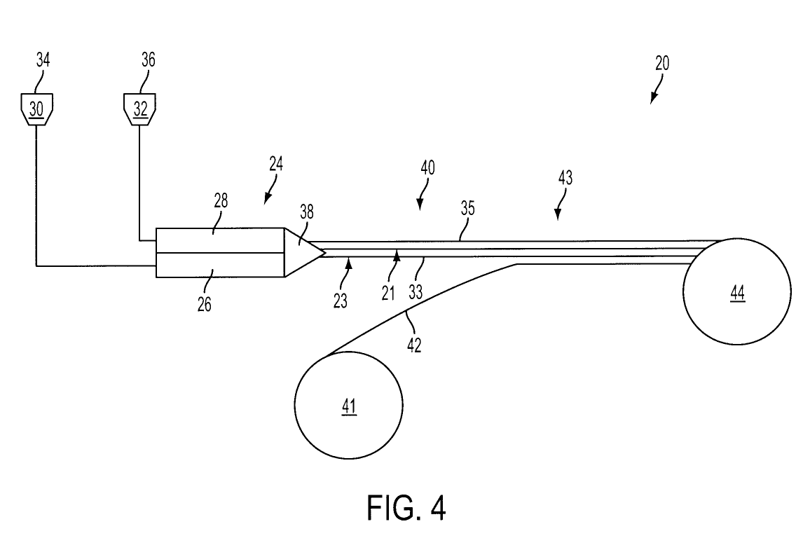

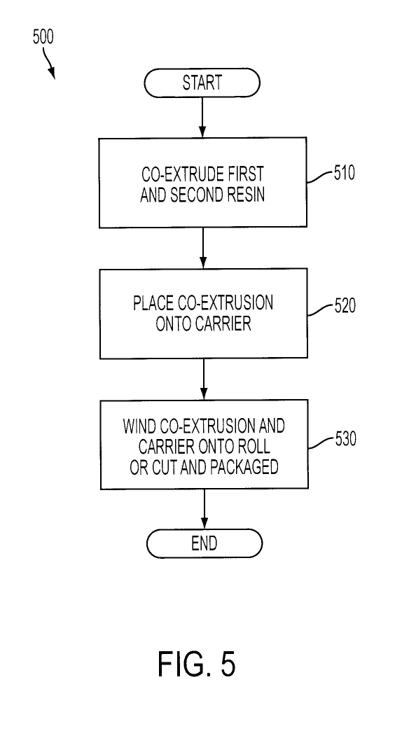

According to one embodiment, the present disclosure features an apparatus 20, FIG. 4, and method 500, FIG. 5, for manufacturing polyurethane film that minimizes and/or reduces the number of imperfections in the polyurethane film. The apparatus 20 and method 500 may comprise an extruder 24 and a die 38 that receives a first and a second resin 30, 32 (for example, from a first and a second hopper 34, 36, respectively) and co-extrudes a first and a second layer 33, 35 comprising the first and the second resins 30, 32, respectively (act 510). The first resin 30 may comprise polyurethane or the like while the second resin 32 may comprise a polyester, polypropylene, or the like. The second resin 32 may be selected to have melt and flow temperature properties similar to those of the first resin 30. The first and second resins 30, 32 may also be selected to have appropriate properties such that the resins 30, 32 may be peeled apart from each other. For example, the second resin may comprise a polyolefin (such as, but not limited to, high or low density polyethylene), any non-polar polymer, and any material that has been doped such that it substantially will peel apart from the first resin 30 (for example, but not limited to, adding silicon, Teflon®, wax, and/or the like).

The extruder 24 may include any extruder 24 and die 38 known to those skilled in the art capable of co-extruding the two resins 30, 32 and forming the first and second layers 33, 35 such as, but not limited to, an AB extruder 24 having a first and a second screw 26, 28 and a flat AB feed block die 38. The first and second resins 30, 32 may be co-extruded such that a first surface 21 of the first layer 33 substantially contacts the second layer 35. According to one embodiment, the first surface 21 of the first layer 33 may be substantially coextensive with the second layer 35.

The co-extrusion 40 may be may be placed onto a carrier 42 such that a second surface 23 of the first layer 33 (i.e., the surface 23 of the first layer 33 generally opposite the first surface 21) substantially contacts the carrier 42 (act 520). According to one embodiment, the second surface 23 of the first layer 33 is substantially coextensive with the carrier 42. The first layer 33 may be placed on the carrier 42 prior to the crystallization of the first resin 30. The carrier 42 may include 0.5-3 mils polyester, polypropylene, or polyethylene, treated paper, or the like that may be unwound from a roll 41.

Once the co-extrusion 40 has been placed on the carrier 42, the combination 43 of the co-extrusion 40 and carrier 42 may be wound onto a roll 44 or cut into the desired shape and/or packaged (act 530).

It should be noted that the second resin 32 may form a film/layer that protects the first side 21 of the first resin 30 from the back of carrier 42 when wound, thereby minimizing the number and frequency of imperfections introduced into the first layer 33. Additionally, the apparatus 20 and method 500 reduces and/or eliminates wrinkles, air pockets, and blemishes that are formed when introducing a separate, crystallized film at the nip. When the co-extruded, second layer 35 is removed, the first layer 33 is left with a smooth, clean surface. As a result, the first layer 33 may be protected on a first side 21 by the second layer 35 and on the second, opposite side 23 by the carrier 42.

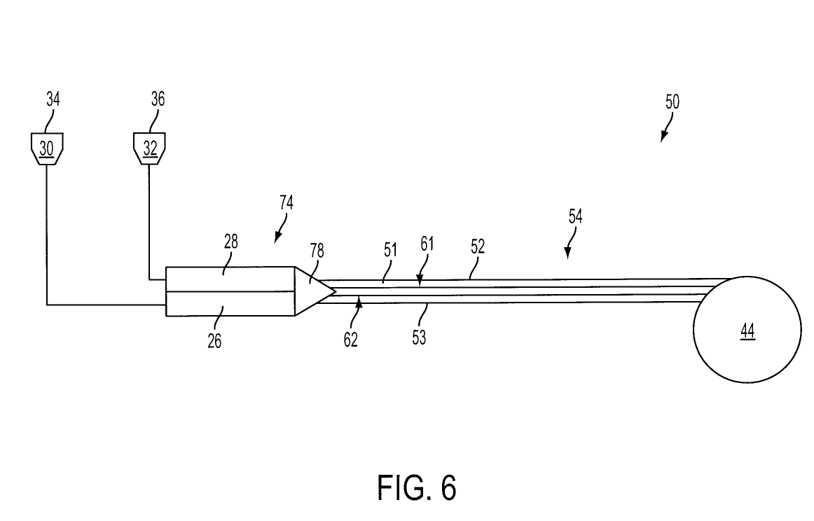

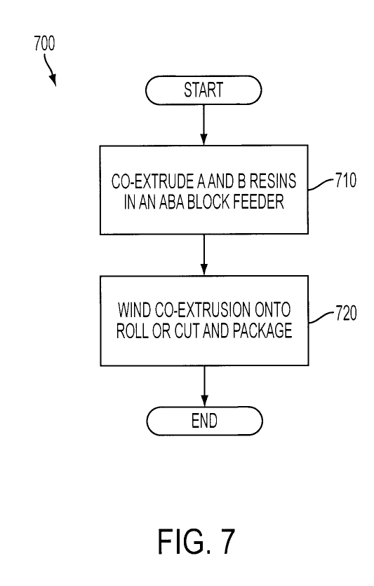

According to an alternative embodiment, the present disclosure features an apparatus 50, FIG. 6, and method 700, FIG. 7, for manufacturing polyurethane film that minimizes and/or reduces the number of imperfections in the polyurethane film. The system 50 may comprise an ABA extruder 74 that may extrude an ABA film 54 from a die 78 (act 710). The ABA extruder 74 may include any extruder known to those skilled in the art for creating an ABA film such as, but not limited to, an ABA extruder 74 having two separate screws 26, 28 and an ABA feed block die 78 fed by two separate hoppers 34, 36, respectively.

The ABA film 54 may comprise a first layer 51 of a first resin 30 and second and third layer 52, 53 of a second resin 32. The first resin 30 may comprise polyurethane or the like and the second resin 32 may comprise polyester, polypropylene, or the like. A first and a second surface 61, 62 of the first layer 51 may substantially contact the second and third layers 52, 53, respectively, such that the first layer 51 may be “sandwiched” between the second and third layers 52, 53. According to one embodiment, the first and second surfaces 61, 62 of the first layer 51 may be substantially coextensive with the second and third layers 52, 53. The ABA film 54 may then be wound onto a roll 44 or cut into the desired shape and/or packaged (act 720).

The second and third layers 52, 53 of the second resin 32 may protect both sides 61, 62 of the first layer 51 of the first resin 30. In use, the second and third layers 52, 53 may simply be removed from the first layer 51 thereby reducing or eliminating the imperfection in the surfaces 61, 62 of the first layer 51. As a result, the ABA film 54 may be manufactured without the need of a carrier.

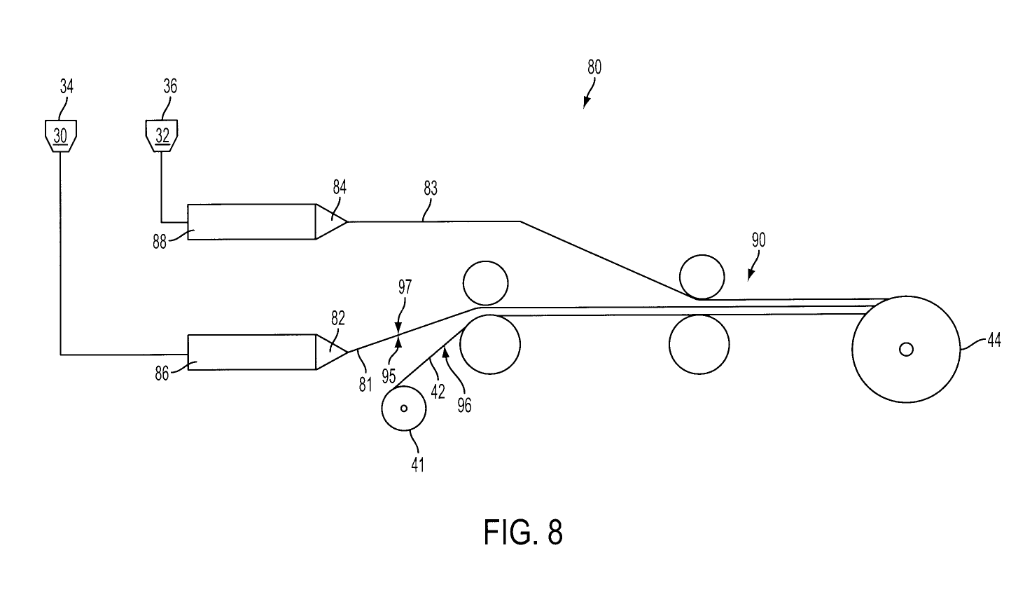

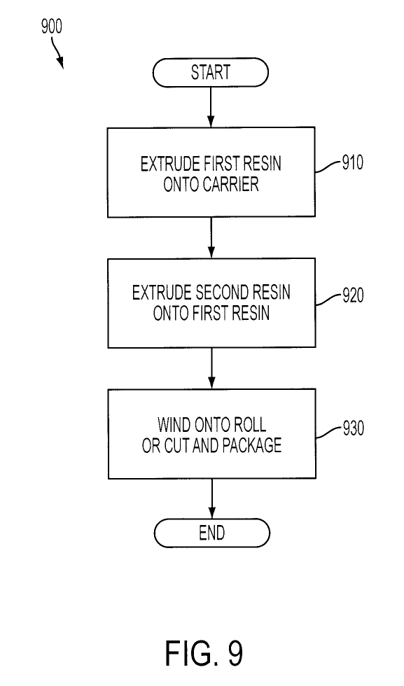

According to a further embodiment, the present disclosure features an apparatus 80, FIG. 8, and method 900, FIG. 9, for manufacturing polyurethane film on a flat die line that minimizes and/or reduces the number of imperfections in the polyurethane film comprising the tandem extrusion of a first and a second layer 81, 83 one right after the other, onto the same web 90. The first layer 81 may comprise a first resin 30 (for example, polyurethane or the like having a thickness of approximately 2-12 mils) that may be formed by a first extruder 86 and die 82 fed from a first hopper 34. The first layer 81 may be extruded onto a carrier 42 (which may be unwound from a roll 41) such that a first surface 95 of the first layer 81 may substantially contact the carrier 42 (act 910). The second layer 83 may comprise a second resin 32 (for example, polyethylene, polypropylene, or the like having a thickness of approximately 0.5-3 mils) that may be formed from a second extruder 88 and die 84 (act 920).

The second layer 83 may be extruded and placed onto the second surface 97 of the first layer 81 after the first resin 30 has cooled and crystallized. The first and second layers 81, 83 may optionally be substantially coextensive. The tandem extrusion 90 may then wound onto a roll 44 or cut and packaged (act 930).

The first and the second surfaces 95, 97 of the first layer 81 may thus be protected by the carrier 42 and the second layer 83, respectively. Specifically, the second layer 83 protects the second surface 97 of the first layer 81 from the exterior surface 96 of carrier 42 when wound. Additionally, tandem extrusion of the first and second resins 30, 32 substantially reduces or eliminates wrinkles, air pockets, and blemishes that may be formed when introducing a separate, crystallized film. Moreover, when the tandemly extruded second layer 83 is removed, the first layer 81 may be left with a smooth, clean surface 97.

Furthermore, the first and second resins 30, 32 may have two very different melt flow temperatures and properties. In co-extrusion, the two materials 30, 32 should have similar melt flow temperatures and properties since they are coming out of the same die at similar temperatures. However, because two separate dies 82, 84 are used in tandem extrusion, this is not a limitation.

According, the present disclosure features novel and non-obvious apparatus and methods of manufacturing protective films. The apparatus and methods according to the present disclosure reduce or eliminate the number and frequency of imperfections in the protective films. Additionally, the apparatus and methods are commercially viable on a large or small scale.

The foregoing description is provided to illustrate and explain the present disclosure. However, the description hereinabove should not be considered to limit the scope of the invention set forth in the claims appended here to.

As mentioned above, the present disclosure is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

1. A method of manufacturing a surface protection film comprising:
providing a first resin comprising a polyurethane;
providing a second resin;
co-extruding said first resin and said second resin through an AB feed block to form a co-extruded film having a first layer of said first resin and a second layer of said second resin substantially contacting each other; and
placing an exterior surface of said first resin of said co-extruded film onto a carrier film, wherein said carrier film protects said exterior surface of said first layer and said second layer protects a second side of said first layer generally opposite said exterior surface.

2. The method of claim 1 further comprising placing said exterior surface of said first resin of said co-extruded film onto said carrier film prior to said first layer crystallizing.

3. The method of claim 1 further comprising rolling said co-extruded film onto a roll such that said carrier film substantially only contacts said second layer.

4. The method of claim 2 further comprising co-extruding said first and said second resins through a flat die.

5. The method of claim 2 further comprising selecting said second resin such that second layer may be peeled apart from said first layer.

6. The method of claim 5 wherein said second resin comprises a polyolefin.

7. The method of claim 6 wherein said second resin comprises low density polyethylene.

8. The method of claim 2 wherein said carrier film has a thickness of approximately 0.5 to approximately 3 mils.

9. The method of claim 8 wherein said carrier film is selected from the group consisting of comprises polyester, polypropylene, polyethylene, and treated paper.

10. The surface protection film according to claim 4.

11. A method of manufacturing a surface protection film comprising:
providing a first resin comprising a polyurethane;
providing a second resin;
co-extruding said first resin and said second resin through an ABA feed block to form a co-extruded film having a first layer of said first resin and a second and a third layer of said second resin substantially contacting a first and a second generally opposite exterior surface of said first layer, wherein said second and third layers protect said first and said second exterior surfaces of said first layer;
wherein said co-extruded film does not require a carrier film.

12. The method of claim 11 further comprising rolling said co-extruded film onto a roll such that said second layer contacts said third layer and said first layer substantially only contacts said second and said third layers.

13. The method of claim 11 further comprising co-extruding said first and said second resins through a flat die.

14. The method of claim 11 further comprising selecting said second resin such that second and third layers may be peeled apart from said first layer.

15. The method of claim 14 wherein said second resin comprises a low density polyethylene.

16. The method of claim 14 wherein said first layer has a thickness of approximately 2 mils to approximately 12 mils.

17. The surface protection film according to claim 16.

18. A method of manufacturing a surface protection film comprising:
providing a first resin comprising a polyurethane;
providing a second resin;
extruding a first layer of said first resin;
placing a first surface of said first layer onto a carrier film;
extruding a second layer of said second resin tandemly with said first layer onto a second surface of said first layer generally opposite said first surface;
wherein said second layer protects said first surface of said first layer and said carrier film protects said second side of said first layer.

19. The method of claim 18 wherein said first and said second resins have different melt flow temperatures and properties.

20. The surface protection film according to claim 19.
